(19) United States
(12) Patent Application Publication
(10) Pub. No.: US 2006/0092177 A1
(43) Pub. Date: May 4, 2006

(54) Input method and apparatus using tactile guidance and bi-directional segmented stroke

(76) Inventor: Gabor Blasko, New York, NY (US)

Correspondence Address: David Aker, 23 Southern Road, Hartsdale, NY, 10530, US

(21) Appl. No.: 10/977,322

(22) Filed: Oct. 30, 2004

(51) Int. Cl. H01H 13/70; G09G 5/00

(52) U.S. Cl. 345/619; 200/1 R; 715/535; 715/703; 345/156; 345/204

(57) ABSTRACT

An input method that is based on bidirectional strokes that are segmented by tactile landmarks. By giving the user tactile feedback about the length of a stroke during input, dependence on visual display is greatly reduced. By concatenating separate strokes into multi-strokes, complex commands may be entered, which may encode commands, data content, or both simultaneously. Multi-strokes can be used to traverse a menu hierarchy quickly. Inter-landmark segments may be used for continuous and discrete parameter entry, resulting in a multifunctional interaction paradigm. This approach to input does not depend on material displayed visually to the user, and, due to tactile guidance, may be used as an eyes-free user interface. The method is especially suitable for wearable computer systems that use a head-worn display and wrist-worn watch-style devices.

### BACKGROUND OF THE INVENTION

1. Field of the Invention

The present invention relates to apparatus and methods, used in mobile computing. More particularly, it relates to those apparatus and methods in which small devices may easily and efficiently process input data.

2. Background Art

Generally, there have been a variety of devices that are useful for performing mobile computing functions. These include PDA's, computerized watches or watch computers, and other mobile devices.

Mobile devices are often used in situations wherein the user's attention is divided between the environment and the use of the device itself. If the mobile device “pushes” information to the user at unexpected times and/or requires the user to take immediate action (for example confirm a notification) an input method is needed that allows the user to execute these tasks as quickly as possible to minimize the time allocated to using the device.

Additionally, it is advantageous for the input method/user interface to overcome the following disadvantages of mobile devices:

The need to take a device such as a PDA out of its case, take out the stylus, or flip open a cell phone, which adds to the time of use.

The dependence on the display for visual feedback such as is the situation for stylus based devices.

The need for content load and precision during interaction. For example, PDA's require the user to precisely move the stylus on the two dimensional plane of the touch sensitive screen. Devices that use a multitude of buttons required the user to move fingers from button to button in a coordinated way.

The need for increased social acceptability. Present devices are not socially acceptable, as the use of the device is generally not inconspicuous. Other people in the environment are aware of the fact that device is being used.

A narrow breadth of instantaneously accessible functionality. While functionality may be increased by the use of navigation, generally, visual feedback is required for navigation, especially where functionality is organized in a hierarchical manner. Navigation in such systems places a high cognitive load on the user and is therefore time consuming and error prone.

More than one hand is generally required to use the device. For example, with PDA's, one hand is required to hold the device and the other to use the stylus. Further, mobile devices are generally used in brief bursts, when the user may be on the move and/or may have a hand occupied by holding objects.

A watch computer having an appropriate input mechanism would overcome some of these disadvantages. Wrist-worn devices are one of the most socially acceptable forms for wearable computing. Their main benefits of portability and quick accessibility are a result of their small size. However, their constraints and disadvantages are also due to their small size. Their physical form limits the number of mechanical input devices with which they can be equipped, while their small screen size limits the amount of textual and graphical information they can display. Desktop user interfaces cannot be easily adapted to this computing domain. Alphanumeric user interfaces using typed commands are inappropriate, since there is not enough space on the device to implement a keyboard (not even a chording keyboard) and as discussed above, other character entry methods (such as the stylus-based gesture systems used on PDAs) are quite time consuming and tedious for extended use. Graphical user interfaces that are dependent on manipulating an on-screen cursor are very versatile for both desktop and PDA platforms. By using the cursor with a multitude of on-screen widgets for application control and parameter adjustment, a wide range of user interfaces can be built. However, due to the limited screen size of wrist-worn devices, user interfaces that require the navigation of an on-screen cursor, or that are highly dependent on visual feedback, are unsuitable.

Furthermore, any user interface that requires a user's visual attention can be problematic in a mobile setting in which the user must attend to the surrounding environment.

Thus, at the present time, there are no methods for entering information that are particularly efficient and solve the remaining problems of wrist worn devices, such as the need for navigation, which increases interaction time, is conspicuous, and requires the user to look at the device.

### SUMMARY OF THE INVENTION

It is an object of the invention to provide a method of entering data into a mobile device that eliminates the above disadvantages inherent in prior devices and data entry methods.

It is a further object of the invention to provide a data entry method that is accurate, efficient and inconspicuous.

It is another object of the invention to provide a data entry method that is especially useful with small mobile devices such as computers in watch formats.

The present invention permits a large breath of different inputs, using the gestures disclosed herein, to be provided to a tactile guided, touch sensitive, sensor input array of a wearable computer. Each gesture may be assigned (or mapped) to the execution of a command, invocation of functionality, or entry of data. If some analog to digital processing is performed on signals from the sensor, the sensor inputs may have different meaning based on the pressure exerted on the sensors.

The objects above and others are achieved in accordance with the invention by a method for a user to provide input to an apparatus having a periphery, a plurality of sensors arranged about the periphery, and a series of tactile landmarks generally aligned with the sensors. The method comprises placing a finger on one of the sensors in accordance with guidance received from a first of the tactile landmarks; moving the finger in a first direction for a first distance to a second of the sensors as guided by a second of the tactile landmarks; moving the finger in a second direction opposite the first direction, for a second distance to one of the plurality of sensors; and using locations of the first sensor, the second sensor, and the third sensor, the first distance and the second distance to define unique input to the apparatus.

The input may comprise function commands and data, wherein distance moved represents a function command, and initial position represents data. Moving of the finger in a first direction, and an initial position of the finger may correspond to a command, and moving of the finger in a second direction and distance moved in the second direction may correspond to data.

Preferably the method further comprises moving the finger along a tactile guide aligned with the sensors.

The apparatus may be a watch computer equipped with a touch sensitive display and the tactile guides may be features of the display frame. Alternatively, the sensing apparatus may be physical features of a bezel.

The method is advantageously performed without viewing the device. Available inputs may be supplemented by using single direction gestures. The method may further comprise simultaneously using an additional finger to enter additional input.

The inputs may include commands to the apparatus comprising at least one of commanding a speech synthesizer to output received text as speech; commanding that received data be displayed, and sending a confirmation of receipt to a notification system.

The invention is also directed to a mobile computing device having a series of sensors for receiving inputs in accordance with the various aspects of the method as set forth above. The mobile computing device may be configured as a watch computer. Generally, the tactile landmarks are in a different plane than portions of the sensors that are contacted to provide inputs.

### BRIEF DESCRIPTION OF THE DRAWINGS

The foregoing aspects and other features of the present invention are explained in the following description, taken in connection with the accompanying drawings, wherein:

FIG. 1A is an enlarged plan view of a watch computer for use with the method in accordance with the invention.

FIG. 1B is a schematic diagram of the arrangement of sensors of the watch computer of FIG. 1A.

FIG. 2A is an enlarged plan view of another watch computer for use with the method in accordance with the invention.

FIG. 2B is a schematic diagram of the arrangement of sensors of the watch computer of FIG. 2A.

FIG. 3 is a conceptual view of the manner in which the effective display area can be of an apparatus in acordnce with FIG. 1A or FIG. 2A may be increased.

FIG. 4 is a conceptual view of the manner in which the present invention may be used to simulate parameter adjustment devices or widgets.

FIG. 5A is a dial wheel widget implementation of the invention.

FIG. 5B is an example of a multi-widget implementation of the invention.

FIGS. 6A-1, 6A-2 and 6A-3 represent another dial wheel widget implementation of the invention.

FIGS. 6B-1, 6B-2 and 6B-3 represent a slider widget implementation of the invention.

FIGS. 7A-1, 7A-2 and 7A-3 and FIGS. 7B-1, 7B-2 and 7B-3 represent independent dial wheel implementations of the invention.

FIGS. 7C-1, 7C-2 and 7C-3 and FIGS. 7D-1, 7D-2 and 7D-3 represent independent slider implementations of the invention.

FIG. 8 illustrates menu navigation in accordance with the invention.

FIG. 9 illustrates menu hierarchy traversing shortcuts with concatenated strokes in accordance with the invention.

FIG. 10 is a system overview of a wearable password management system in accordance with the invention.

FIG. 11 illustrates two methods for selecting pictograms from eight content cards, in accordance with the invention.

### DETAILED DESCRIPTION OF THE PREFERRED EMBODIMENT

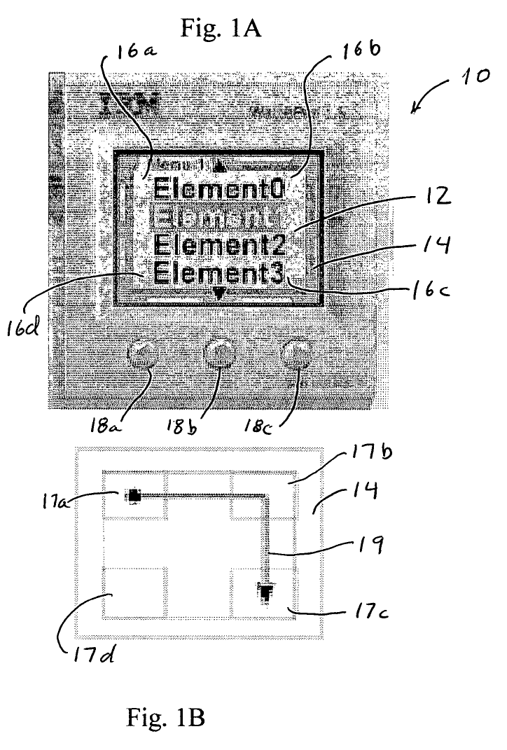

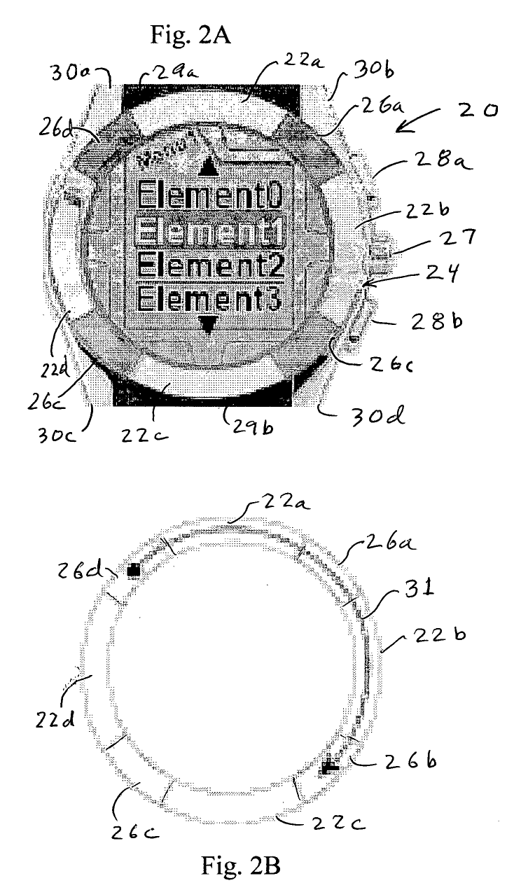

Referring to FIG. 1A and FIG. 2A, there are shown plan views of watch computers 10 and 20, respectively, which may be used with the present invention. Although the present invention will be described with reference to the embodiments shown in the drawings, it should be understood that the present invention can be embodied in many alternate forms of embodiments. In addition, any suitable size, shape or type of elements or materials could be used.

The physical design of watches has not changed much over the past few decades, even though the range of features they provide has expanded. Traditional mechanical watches, as well as modern computer watches, share common traits that can be exploited in the design of a watch computer interface: they have a face/display and, around it, a bezel/display frame.

The watch computer 10 illustrated in FIG. 1A is the IBM/Citizen WatchPad, a preferred computer watch for use with the invention. Watch computer 10 has a transparent touch screen 12 surrounded by a plastic frame 14 and its prototype user interface monitors finger tapping in the four quadrants 16a, 16b, 16c, and 16d of the touch screen, each having a sensor as described in FIG. 1B, and simulating buttons. These quadrants are significantly tangible, since the corners of the frame can be easily felt by the finger; therefore, these corners as referred to as tactile landmarks. The watch computer 10 may have a liquid crystal or dot matrix display visible through the touch screen 12, for displaying time, graphics and data. A series of buttons 18a, 18b, and 18c may provide control inputs for the watch or for other functions. A wristband (not visible in FIG. 1A) may be fastened to the back of the housing of watch computer 10 to be used in securing watch computer 1o to a user's wrist.

As shown in FIG. 1B, a sensor 17a, 17b, 17c and 17d is associated with a respective quadrant 16a, 16b, 16c, and 16d. Arrow 19 represents a possible input gesture.

FIG. 2A illustrates a watch computer 20 of more conventional design, and without a touch screens. While watch computer 20 has a face of circular design, it will be understood that the face may be of a different shape (e.g. square, hexagonal, or octagonal). Watch computer 20 has tangible tactile landmarks 22a, 22b, 22c and 22d (e.g., bumps, extrusions, or hollow sections) on its bezel 24. Sensors 26a, 26b, 26c and 26d for providing inputs to watch computer 20 may be arranged between the tactile landmarks 22a, 22b, 22c and 22d. A crown 27, a first button 28a, and a second button 28b may be provided along the edge of the case of watch computer 20 to provide control inputs for the watch or for other functions. Ends 29a and 29b of a wristband each may be attached to respective protrusions 30a and 30b, and 30c and 30d, of the housing, by, for example, an appropriate watchband pin (not shown), in a manner well know in the art.

In FIG. 2B, arrow 31 represents a possible one directional input gesture.

Because of the small size of the watch, and its location on the wrist, it is easy to home the hand to the device, and the index finger to a given landmark, without looking at the device. For example, the index finger may be positioned quickly by holding the watch between the thumb and the middle finger. Furthermore, since the device is very small, it is easy to execute a gesture by moving the fingertip from one tactile landmark to another, as illustrated in FIG. 1B; for example, from corner to corner along the frame of the touch screen 12, or from extrusion to extrusion on the bezel 24 around the watch face in FIG. 2A. It will be understood that the tactile landmark are in a different plane than the portions of the sensors contacted by the finger, and so are easy to recognize by touch alone.

Without looking at the device, the user can determine, through the sense of touch alone, the length of a given stroke, as measured in landmark-to-landmark length. The tactile landmarks serve as starting, stopping, and intermediate points, as the fingertip of the user moves in a circular gesture on the edge, along the frame of a touch screen, or on the bezel of a watch. A circular gesture may begin in either a clockwise (CW) or a counter-clockwise (CCW) direction, and this direction may change upon reaching a certain landmark. For example if there are four corners, two directions (CW/CCW), and strokes may be from one to three landmarks in length, the number of possible strokes that may be executed is 24. This already offers a large number of command-to-stroke mapping possibilities. However, the user is allowed to execute a stroke in one direction, reach a landmark, and then continue the stroke in the other direction, without lifting the finger off the sensor, then after a given length switch directions again, and so on. If such concatenated multi-strokes are allowed to include one direction switch, but the length of the sub-strokes is restricted to three, the number of quickly executable stroke possibilities increases to 72 (4×2×3×3). If single gestures are added, there are a total of 96 possible input gestures. If such concatenated multi-strokes are allowed to include two direction switches, but the length of the sub-strokes is restricted to three, the number of quickly executable stroke possibilities increases to 216 (4×2×3×3×3). In addition to mapping all these different multi-strokes to different functions, it is also possible for concatenated sub-strokes to represent not only control/command functions, but also encode preset parameter data values. This bi-directional segmented gesture system can be implemented on any device that can sense motion/rotation along one dimension that loops around, where this motion is segmented by landmarks.

The amount of graphical and textual content that can be displayed on the approximately 1 square-inch display of a watch computer is very limited. Even if the display resolution is very high (>300 dpi), the font size used to display textual content on the screen must be large enough to be legible at arm length. This allows the user to read the information at a glance, in less then a second. For example, there may be situations in which the user needs to check the device for important information, but may feel that it is socially inappropriate and too time-consuming to use a hand-held device, such as a PDA or cell phone. The convenience of being able to access information in less than a second is a highly influential factor in determining how frequently the device is used.

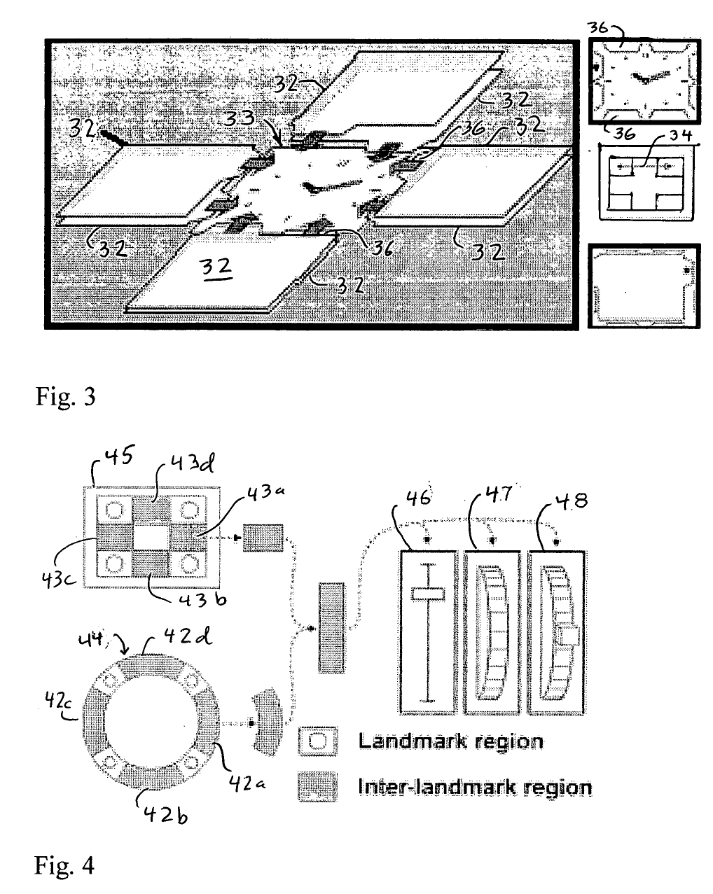

An important method for speeding up interaction with a watch computer is to increase the amount of output that the device conveys to the user. As illustrated in FIG. 3, this may be accomplished by the use of content cards 32 which are virtual screens displays that may be “dragged” on to the screen of a watch computer 33. These content cards 32 serve the purpose of virtually expanding the display area of the watch by an additional eight-fold. As illustrated in FIG. 3, without needing to look at the watch, a quickly executed one-segment stroke 34 may be used to pull a content card into the main screen area by using one of the touch sensitive regions 36. For example, if the main screen is the watch face as shown, a user can pull in a content card (e.g., a daily agenda, a list of recently received messages, or a list of alarms), and direct visual attention to the watch only after the content is displayed; then, after a short delay, the card retracts automatically.

Application designers may distribute their visual content on content cards, unless the short stroke along the edge that pulls in the card is allocated to a parameter-adjustment widget. As discussed below, each card may also serve as an entry point to a separate menu tree, in which a sequence of strokes is used to quickly traverse a menu hierarchy.

If the sensor hardware is not only able to differentiate between landmark and non-landmark contact, but can do so with sub-segment accuracy, multiple methods of discrete and continuous parameter adjustment are possible. In the arrangements shown, along the inner frame of the touch screen (or on the circular bezel), the regions between the four landmarks create two horizontal and two vertical linear segments, as shown in FIG. 1A and 2A. These inter-landmark linear segments can be used to simulate three interaction devices, such as a slider, spinner wheel and spring-loaded wheel. Additionally, since the landmarks and the segments between them are arranged in a ring, it is also possible to implement a virtual dial by dragging the finger over multiple landmark and non-landmark segments of the sensor in a circular stroke.

Referring to FIG. 4, the inter-landmark regions 42a, 42b, 42c and 42d of the bezel 44, (or the inter-landmark regions 43a, 43b, 43c and 43d of a rectangular screen 45) may be used to implement four different types of touch widgets. The first three types of virtual widgets in these regions may be implemented by monitoring when the fingertip contacts, releases, or is dragged over the touch screen surface. A virtual slider 46 can be made by monitoring the one-dimensional position of the finger's centroid along the length of an inter-landmark region (i.e., horizontal position for the top and bottom regions, and vertical position for the left and right regions). By repeatedly stroking the touch sensitive segment, a virtual spinner wheel 47 can be implemented. A virtual spring-loaded wheel 48 can be realized by monitoring the direction and the length of the finger dragging motion, to establish a vector starting from the location of initial surface contact. Since current touch screen technology reports only the centroid of the contact area, part of the finger may move out of the inter-landmark region while controlling the widget. However, even if the centroid moves out of the inter-landmark region, the widget remains active, as long as contact is maintained. As a result, the sensor has a feel that is significantly larger than the inter-landmark region itself.

A fourth type of virtual widget that may be created is a virtual dial wheel. While the spinner wheel is simulated by linearly stroking the surface as if the virtual wheel's axis were parallel to the plane of the touchscreen, the dial wheel is simulated by monitoring the circular motion of the fingertip as it is dragged over the regions, as if the wheel's axis were perpendicular to the plane of the touch screen.

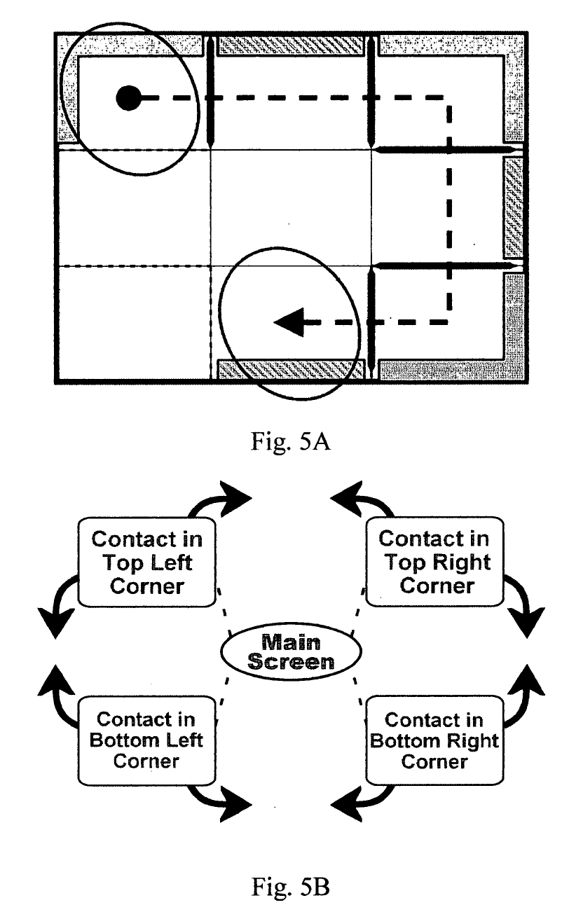

To implement the dial wheel in a computationally simple way, the two-dimensional circular motion of the finger, is not monitored, but rather, just the occurrence of region crossings, for example moving the finger from a landmark region to an inter-landmark region. Thus, unlike the first three widgets, the dial wheel widget requires the traversal of at least two regions, and can be invoked by starting in a landmark region. As discussed earlier and illustrated in FIG. 1B and FIG. 2B, a user can discriminate without looking at the device, based on touch alone, among the eight different regions. Thus, if a discrete variable is incremented by one when the finger's centroid crossed a region boundary in the CW direction, and decremented by one when the finger's centroid crossed a region boundary in the CCW direction, a user could adjust a discrete variable on an eyes-free basis. The user only has to remember that moving from corner to corner (across an edge) changes a value by two, since two region borders are crossed, and moving from a corner (landmark) to an adjacent edge (inter-landmark), or an edge to an adjacent corner, changes a value by one. For example, if the user wishes to increment a variable by five, then as shown in FIG. 5A, the user only needs to start a CW dragging motion (e.g., from the top-left corner region) and move the fingertip through two edges and stop halfway along the third (in this case, passing through the top edge, top-right corner, right edge, and bottom-right corner, and ending in the middle of the bottom edge). Those people who are comfortable with the layout of the watch and therefore can blindly home their finger to one of the four corners, can easily increment and decrement values this way without needing to look at the display. Each region may be associated with a different dial wheel that may be accessed only by initiating the dialing motion from that region; alternatively, the same dial wheel may be accessed independent of the region that is contacted first.

To increase the number of widgets that can be directly accessed, advantage may be taken of the tactile landmarks, to allow multiple widgets to occupy the same region. For slider, spinner wheel, and spring-loaded wheel widgets, this is possible by requiring that the finger first contact a landmark adjacent to a widget before entering the widget's inter-landmark region. The direction from which the inter-landmark region is entered determines the widget that is invoked. Thus, each inter-landmark region can be associated with two different widgets, doubling the number of widgets that can coexist on the touch-pad, as shown in FIG. 5B. In this case, initial contact with the inter-landmark region might be associated with no widget at all, or with a default one of the two widgets.

In the case of the dial wheel widget, the direction of travel already determines whether it increments or decrements its parameter. However, monitoring the direction of the first region crossing could also be used to associate two different dial wheels with the same region of first contact; a subsequent change in direction would then be used to increment a dial wheel entered CCW or decrement a dial wheel entered CW. For example, if two dial wheels are associated with the top left landmark, incrementing the CW dial wheel by two may be accomplished with a one segment stroke from the top-left landmark to the top-right landmark. In contrast, incrementing the CCW dial wheel by two could be accomplished with a three-segment stroke from the top-left landmark to the left inter-landmark (to invoke the widget and decrement its value by one), back to the top-left landmark (to add back the decrement), and to the top-right landmark (to result in a net increment of two).

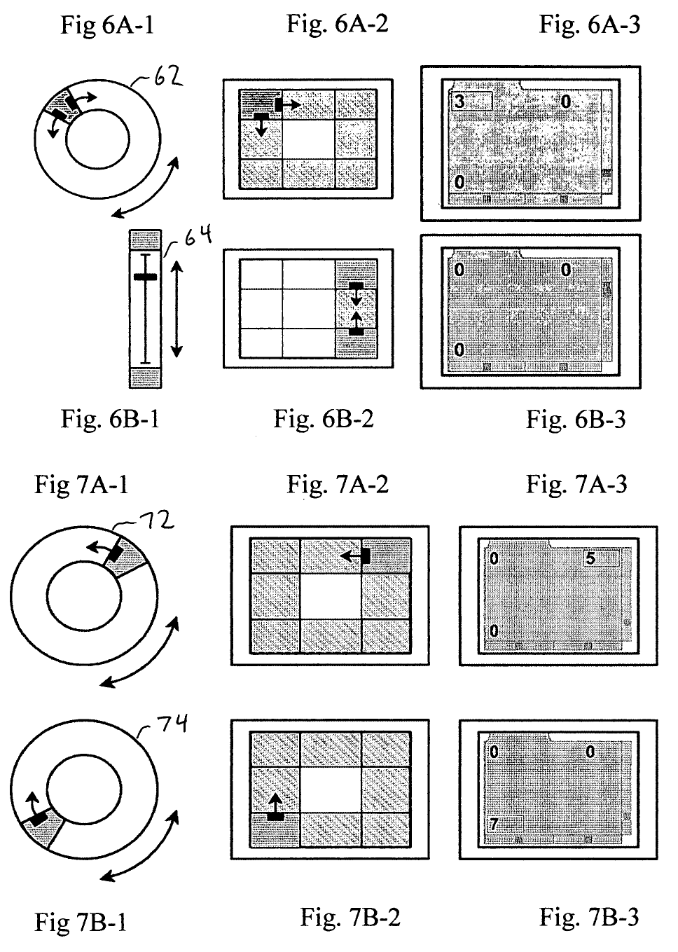

In FIGS. 6A-1, 6A-2 and 6A-3, a dial wheel 62 is shown that can be accessed only by initially contacting the top-left corner. Once the fingertip is dragged CW or CCW out of the top-left landmark, that landmark and the other seven regions (shaded with diagonal lines) can be used to control the dial wheel. The discrete parameter's value can be increased or decreased arbitrarily until the finger is removed from the sensor surface. In FIG. 6B-1, 6B-2 and 6B-3 a slider 64 is shown, that may coexist (share the same sensor segments) with part of the dial wheel of FIG. 6A-1, forming a second controller of the multi-widget. Slider 64, and the single inter-landmark region that is used to control it, is active only if the finger initially makes contact in either the top-right or the bottom-right landmark before moving into the right inter-landmark region.

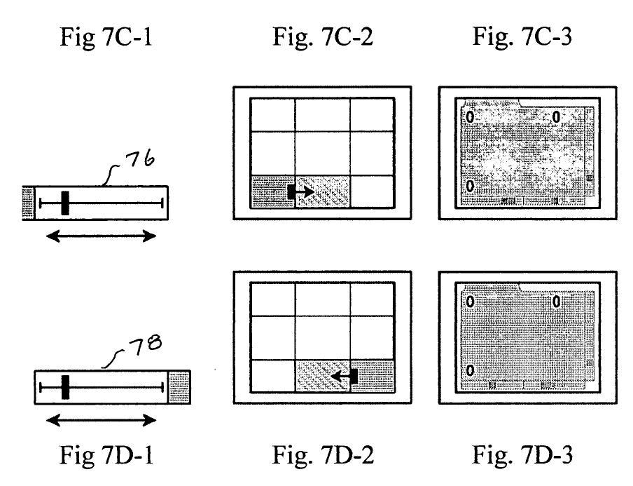

In FIG. 7A-1 and FIG. 7B-1, two independent dial wheels, 72 and 74 respectively, are shown that use overlapping sensor regions during interaction. However, unlike the dial wheel of FIG. 6A, interaction must start in a predetermined direction (CCW for FIG. 7A-1, and CW for FIG. 7B-1). In FIGS. 7C-1 and 7D-1, two independent sliders, 76 and 78 respectively, are shown that use the same inter-landmark region during interaction. The slider of FIG. 7C-1 can be accessed by starting in the same bottom-left landmark as the dial wheel of FIG. 7B-1, if the motion starts in the CCW direction. The slider of FIG. 7C-1 can be accessed by moving in the CW direction from the bottom-right landmark, the same corner that is one of the two entry points for the slider of FIG. 6B-1. Thus, FIGS. 6 and 7 show six independent widgets implemented using overlapping subsets of the landmark and inter-landmark sensor regions. The act of homing the fingertip to the appropriate landmark and beginning the interaction by dragging into an inter-landmark region is both the decisive discriminator amongst the available widgets and part of the parameter adjustment process itself. Therefore, selecting and adjusting a parameter is instantaneous and direct.

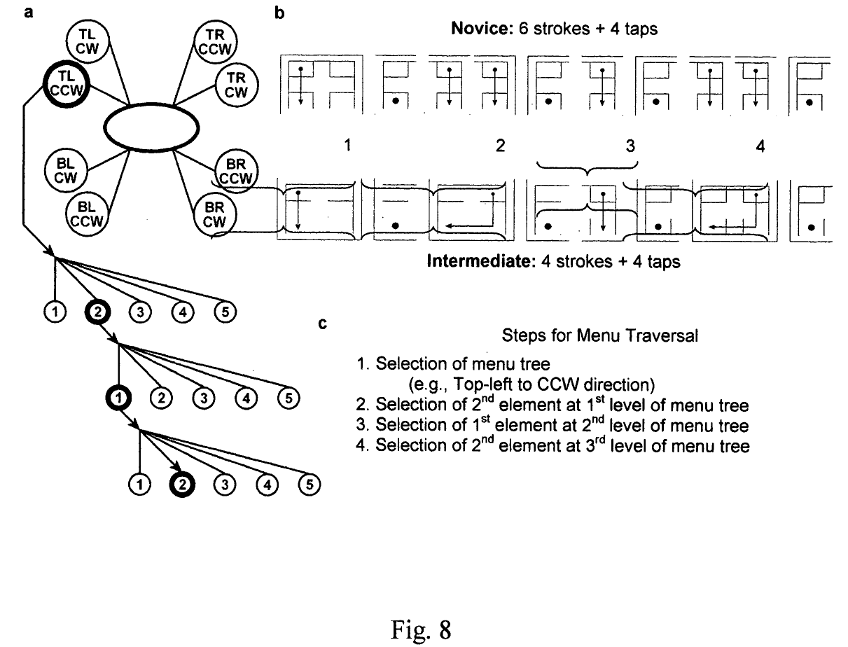

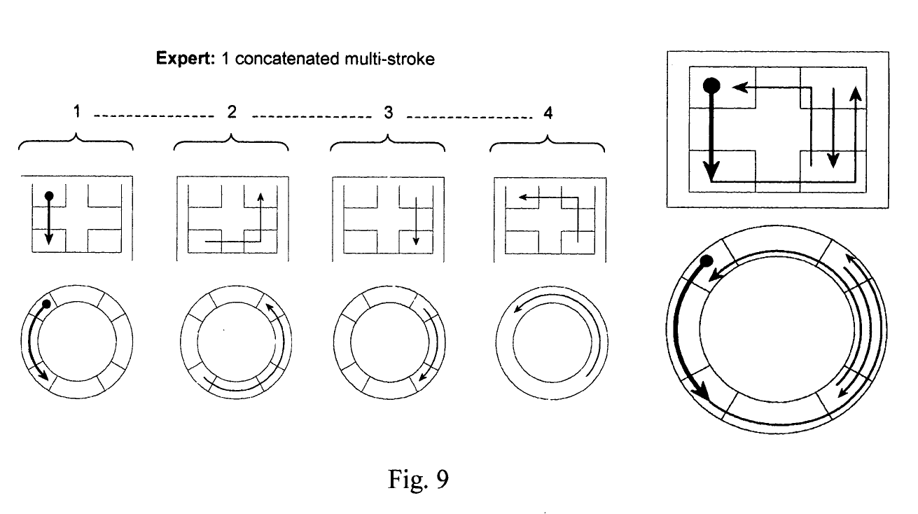

The present invention may also be used as a menu navigation system. A method can be implemented that accommodates novice, intermediate and expert users as explained below and illustrated in FIG. 8 and FIG. 9. Users may be differentiated based on their knowledge of the menu hierarchy and the amount of visual feedback they require during menu traversal. Novices, who are new to the overall system (including its input mechanism, user interface, menu layout, and system capabilities) may use a slower but more “traditional” traversal method. In the touch screen implementation, during the execution of strokes and taps the screen is obscured by the finger; therefore, it is necessary to allow the user to view the small screen's contents and keep track of selections during interaction.

In a four-landmark system it may be possible to access up to eight menu trees with a single-length stroke, depending on the starting landmark and starting drag direction, as shown in FIG. 9. After executing the stroke, the user confirms the choice of the menu tree by tapping on the same landmark, where the stroke ended. Up/down navigation among the listed menu elements is done with single length up/down strokes between the rightmost two landmarks. Taking a step deeper in the hierarchy is done by tapping on the lower-left landmark, stepping back by tapping on the upper-left landmark. Novice users, who are familiar with the menu elements (amongst which a choice can be made) at a given level of the menu tree, may use longer strokes extending over multiple landmarks (similarly to setting a numeric parameter with the aforementioned circular dial widget) to highlight a menu item. Selection of the highlighted element is done with a tap on the lower-left landmark.

Expert users, who know the full layout of the menus and are confident in traversing the menu hierarchy without needing to look at the display, may concatenate multiple strokes together into a long, but swiftly executable bi-directional segmented multi-stroke. Menu tree selection as well as tree traversal may be accomplished at once as illustrated in FIG. 9, showing the traversal shortcut to the same menu element that is illustrated in FIG. 8. After executing a multi-stroke, an expert user may glance at the display to confirm the result of the quick menu traversal and confirm the selection of the menu element by tapping on the lower-left landmark. Alternatively, if the user is confident in knowledge of the menu layout, this navigation stroke and selection tap may all be executed eyes-free due to the fact that the tactile landmarks are felt by the user's finger during the stroke execution. To assist the user, an indication of where the user is in the hierarchy may be given with audible signals or the title of the highlighted menu item may be uttered using speech synthesis.

Many people who work in modern work environments with computing devices and internet access face a major problem; it is necessary to frequently and repetitively authenticate themselves. User names and passwords need to be memorized and retained for off-line and online accounts. A watch computer may serve as a vault of secret account information. For this purpose, the watch computing platform has major competitive advantages over other solutions.

The watch computer's storage allows it to retain information, and its computing capabilities allow it to quickly encrypt and decrypt sensitive information. A device having Bluetooth communication capabilities can wirelessly communicate with external devices and release account information securely to trusted requesters on demand. Software packages that address this problem often keep an encrypted repository of account information; however, these solutions are locked to the computer systems that store them. There are also mobile hardware solutions, such as keycard or USB key fob devices, that also address this problem in a mobile setting where the user needs to move between systems. During use these devices need to be physically connected to a host computer. There may be cases, however, when the user needs access to account information on systems where these devices may not be plugged in. In such cases the watch computer is capable of displaying the account information on its internal screen. Additionally these small key fob tokens may be easily lost, whereas the wrist-worn watch computer is strapped to the user's wrist and therefore much harder to lose. The wrist-worn form factor of the watch makes it easily portable and its placement on the left forearm and quick accessibility with the right hand makes very quick interaction possible.

Some applications, especially those that are connected to a secure corporate network, running on portable devices held in clothing or attached to the body (such as PDA's) require the owner to authenticate herself every time sensitive content is accessed. Often users of such devices, in order to minimize the inconvenience of this authentication step compromise their data's security by setting short, insecure passwords to make it possible to enter them quickly, or sometimes users decide to disable the owner authentication step totally. Since a watch computer is far harder to lose, the wearer's identity does not need to be challenged before every time sensitive content within the device is accessed. Instead, a more difficult user authentication challenge may be posed, that can establish a trust relationship between the watch and its wearer for a longer time period. In the following sections, the interactions with the password management system are described, assuming that the wearer's identity has already been authenticated. Next, presented is the user interface of a pictogram password-based authentication challenge, which the user is required to pass before the watch releases sensitive content.

A user may move between different computing environments in which various levels of trust may exist with the computer being used for application or internet web page access, for which account information may be needed.

In a trusted setting, such as a corporate office, a software daemon can be installed on trusted host computers that facilitates secure communication with the user's watch. Such a daemon may assist a user with the login procedure needed to access various web-based electronic mail services. When the user navigates her browser on the host computer to a web page that asks for the user's login information, the user may request assistance from the password management software on her watch.

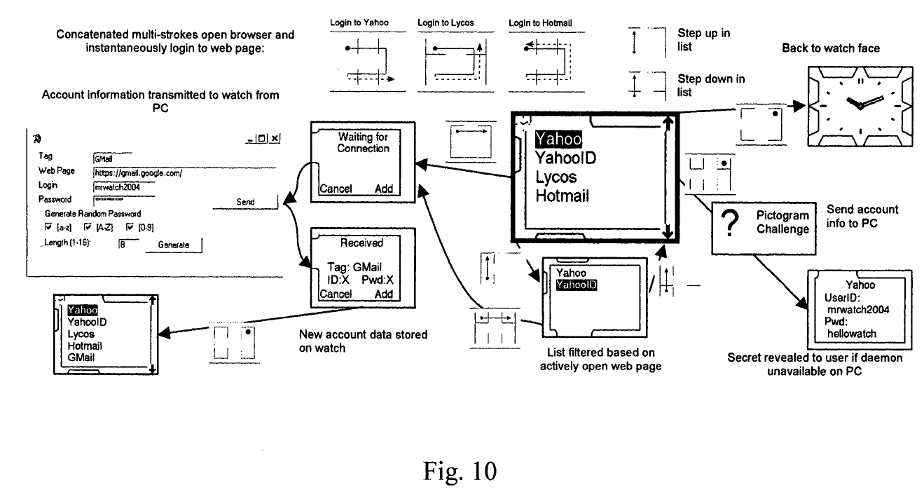

As illustrated in FIG. 10, on the main screen, a list of accounts is presented to the user, as well as content cards that provide additional functionality. A user may navigate up and down this list by using the novice or intermediate menu method earlier presented, which uses a dial-wheel widget and selection button to select an item in the list. Since this list may be quite long the watch is allowed to query the browser running on a personal computer (PC). By executing a stroke the watch sends a message to the PC, and the PC replies with the URL address of the active web page. This URL address is used to truncate the list of accounts, so that only those that are associated to the active web page are displayed on the pulled-in content card.

If the user selects an account on the long or the truncated list and the watch has already authenticated the wearer, two things can occur. If the watch can securely connect over Bluetooth to the deamon running on a trusted PC the account login and password information is automatically entered into the appropriate fields of the web-page. If a secure connection cannot be established, or there is no trusted deamon on the PC, the watch displays the account information on its own screen.

From the main screen it is also possible to add new entries into the list. This is done my pulling in another content card, which also initializes a connection with the PC and the opening of a dialog box on the PC into which the account information is entered and the data sent back to the watch, at which point the new entry may be permanently added to the list. The dialog box also offers the system to randomly generate random long passwords for the user. Since the watch keeps track of passwords and it is not necessary for the user to remember passwords, by using long and random passwords security is improved.

To demonstrate the utility of quickly executable concatenated multi-strokes, a gesture is introduced wherein the first part represents the “automatically login” command, and the length of the second sub-stroke indicates which web page the system should automatically log the user into once the system has opened a new browser window for the user. Using a concatenated multi-stroke, which can be executed without looking at the watch, in less than a second, the user can log in to a favorite webpage almost instantaneously.

For the purpose of challenging the watch's wearer to prove identity, a pictogram password-based authentication system may be used. Pictogram passwords are useful on mobile devices which are not equipped with keyboards and are immune to dictionary attacks. The human visual memory system is very capable of retaining pictogramic passwords for extended periods of time, and in cases where the pictograms are constructed from shapes or pictures that are meaningful to the user, they can be easily reconstructed if forgotten.

By using segmented strokes and content cards a pictogram selection method is created, which with experience turns the authentication system from a pictogramic into a gestural password system. A 32 pictogram alphabet of elements, which are distributed around the main authentication screen on eight content cards, each containing four pictograms, may be used.

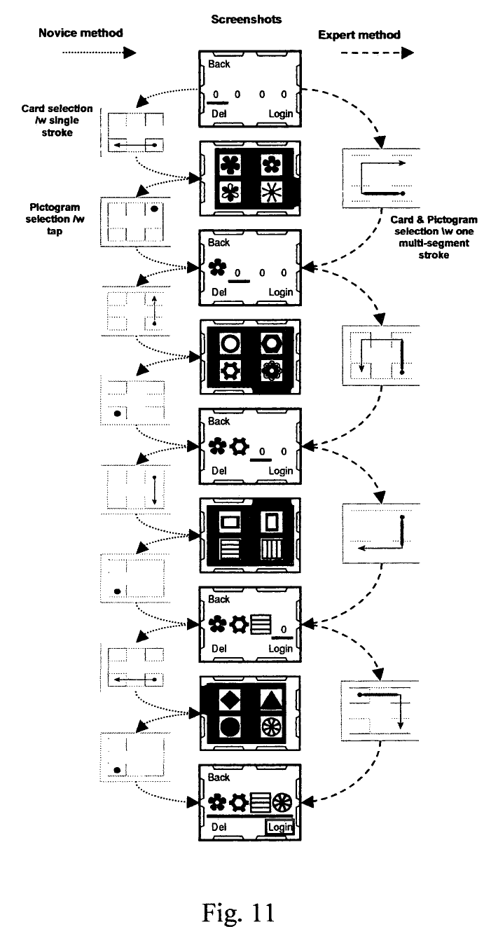

As illustrated in FIG. 11, the user needs to construct a password of four pictograms to prove her identity. A novice user who has not yet fully memorized which content cards contain the pictogram elements of her password may choose to pull in all content cards one-by-one, and browse for the appropriate card holding the next element of the password. After executing a single-segment stroke, the content card is presented, with four pictograms displayed in the four quadrants of the screen. At this point, the user may lift the finger off the screen, see the pictograms, and either tap in one of the four quadrants to select the corresponding pictogram, or alternatively continue browsing by pulling in other content cards with single-segment strokes. In this way, a single pictogram is selected with a specific single-segment stroke and tap in a quadrant, as illustrated in FIG. 11. After a few trials at entering their passwords, users quickly memorize the appropriate content card/stroke and following quadrant region that needs to entered.

An expert user, who has already memorized her own password and has memorized the sequence of appropriate starting strokes and following quadrants, may easily progress to a more advanced method of entering the password. This is done by creating a stroke gesture for each pictogram. The simple recipe for pulling in a content card and selecting a pictogram at the same time is to execute a single segment stroke from the appropriate landmark and appropriate direction corresponding to the content card that contains the pictogram, and to continue the stroke in the same direction along the edge of the display's frame until the quadrant holding the desired pictogram is reached. While performing this quick gesture, the user does not need to look at the display, since the user can easily home the finger to the appropriate landmark and drag the finger along the edge to the appropriate corner, using tactile guidance alone. In this way, a four-pictogram password may be selected entirely eyes-free and submitted to the watch to authenticate the user. The successful password submission is acknowledged with a discreet vibration. Over-the-shoulder peeking by others or other environmental vulnerabilities may be avoided with this password entry method, since the entire password may be submitted, and success acknowledged eyes-free, with only silent haptic feedback.

Thus, the present invention is directed to a cursorless user interface environment, which enable, eyes-free input that depends minimally on visual feedback and may highly benefit other device platforms and domains. Wearable computing systems that use head mounted displays, which also suffer from small display sizes, may be equipped with a wrist-worn touch sensor allowing similar application control as on wristwatches.

The presented input methods, being based on haptics and tactile guidance, allow for a subset of the presented concepts to be transferred to display-less devices as well. By replacing the small display with a speech synthesis engine a system can be created using tactile landmarks, segmented strokes, and concatenated multistrokes, as well as multi-widgets for visually impaired people.

It will also be recognized by one skilled in the art that alphanumeric data may be entered by the use of appropriate gestures to contact the sensors of the watch computer, in a manner similar to that used for stylus based text entry.

In order to implement sensing of finger position, each sensor is connected to an input of a microprocessor in the watch computer 10 or 20, via suitable signal conditioning circuitry, so that if the sensor is activated, a signal indicating such activation is recognized by the microprocessor. The implementation of programming to determine stroke initial position (the position of the first sensor activated), the position of sensors subsequently activated, and the stroke length are easily implemented in software or hardware, or in any combination thereof.

As an example, if shortcuts are to recognized, it is possible for each sensor to have a unique number associated with its activation, and to merely record the sequence of such numbers. A look-up table with those number sequences, and with a unique instruction for each sequence, is entered, and the appropriate instruction is read out for the sequence of numbers corresponding to the sensors touched.

More generally, the location of the first sensor activated is noted by recording its number, and the number of sensor, or distance traversed, is recorded as a positive number for movement in one direction, and as a negative number for movement in the opposite direction. This approach offers more flexibility in that it is possible to have a much larger number of combination, in that the distance traveled, in terms of the number of sensors activated during travel in one direction is not limited to a small number. Thus, in this approach, an initial position is stored, as well as a sequence of signed numbers indicating motion of the finger in clockwise and counter-clockwise directions.

The sensors used in various apparatus in accordance with the invention may be bases on capacitive, resistive or optical sensing technologies, as is well known art, or may be any one of other sensing to be developed in the future.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for a user to provide input to an apparatus having a periphery, a plurality of sensors arranged about the periphery, and a series of tactile landmarks generally aligned with said sensors, comprising:
placing a finger on one of said sensors in accordance with guidance received from a first of said tactile landmarks;
moving the finger in a first direction for a first distance to a second of said sensors as guided by a second of said tactile landmarks;
moving said finger in a second direction opposite said first direction, for a second distance to one of said plurality of sensors; and
using locations of said first sensor, said second sensor, and said third sensor, the first distance and the second distance to define unique input to said apparatus.

2. A method as recited in claim 1, wherein said input comprises function commands and data, distance moved represents a function command, and initial position represents data.

3. A method as recited in claim 1, wherein the moving of the finger in a first direction, and an initial position of said finger correspond to a command, and the moving of the finger in a second direction and distance moved in the second direction correspond to data.

4. A method as recited in claim 1, further comprising simultaneously using an additional finger to enter additional input.

5. A method as recited in claim 1, further comprising moving the finger along a tactile guide aligned with said sensors.

6. A method as recited in claim 5, wherein the apparatus is a watch computer and the tactile guide is a watch bezel.

7. A method as recited in claim 1, performed without viewing the device.

8. A method as recited in claim 1, further comprising increasing available inputs by using single direction gestures.

9. A method as recited in claim 1, wherein the inputs include commands to the apparatus comprising at least one of:
commanding a speech synthesizer to output received text as speech;
commanding that received data be displayed, and sending a confirmation of receipt to a notification system.

10. A mobile computing device having a series of sensors for receiving input in accordance with the method as recited in claim 1.

11. A mobile computing device having a series of sensors for receiving input in accordance with the method as recited in claim 2.

12. A mobile computing device having a series of sensors for receiving input in accordance with the method as recited in claim 3.

13. A mobile computing device having a series of sensors for receiving input in accordance with the method as recited in claim 4.

14. A mobile computing device having a series of sensors for receiving input in accordance with the method as recited in claim 5.

15. A mobile computing device having a series of sensors for receiving input in accordance with the method as recited in claim 6.

16. A mobile computing device having a series of sensors for receiving input in accordance with the method as recited in claim 7.

17. A mobile computing device having a series of sensors for receiving input in accordance with the method as recited in claim 8.

18. A mobile computing device having a series of sensors for receiving input in accordance with the method as recited in claim 9.

19. The mobile computing device of claim 10, configured as a watch computer.

20. The mobile computing device of claim 10, wherein the tactile landmarks are in a different plane than portions of said sensors that are contacted to provide inputs.
